(19) United States
(12) Patent Application Publication
(10) Pub. No.: US 2006/0255551 A1
(43) Pub. Date: Nov. 16, 2006

(54) Multi-functional work platform

(76) Inventor: Daniel P. Hurt, Watertown, MN (US)

Correspondence Address: Christopher G. Frank;Hangen Law Firm PLLP, 1130 TCF Tower, 121 South Eighth Street, Minneapolis, MN, 55402, US

(21) Appl. No.: 11/434,375

(22) Filed: May 15, 2006

Related U.S. Application Data
(60) Provisional application No. 60/680,872, filed on May 13, 2005.

(51) Int. Cl. B62B 13/18

(52) U.S. Cl. 280/8

(57) ABSTRACT

The present invention provides a multi-functional work platform having a first orientation wherein the work platform functions as a kneeler and a second orientation wherein the work platform functions as a seat. The work platform further includes one or more functional components interchangeably coupled to the support frame of the work platform, such as a wheel attachment or a rocker attachment or a stationary support attachment, to provide additional functional usage to the work platform.

### CROSS-REFERENCE TO RELATED APPLICATIONS

This application claims priority from U.S. Provisional Patent Application No. 60/680,872 filed on May 13, 2005 and entitled MULTI-FUNCTIONAL WORK PLATFORM, the content of which is incorporated herein in its entirety.

### BACKGROUND OF THE INVENTION

The present invention relates generally to the field of personal support apparatus such as chair seats and kneelers. More specifically, the present invention relates to a working platform that operates as either a chair or kneeler and may incorporate a number of functional orientations and capabilities.

### SUMMARY OF THE INVENTION

The present invention provides a multi-functional work platform for use as a kneeler or as a seat. Additionally, functional components may be incorporated with the work platform such as a rocker attachment, a wheel attachment, and a stationary support attachment, for example, to add functionality and ease of use.

The multi-functional platform includes a base panel having a first surface and an opposing second surface. The base panel is supported by a support frame having a first end and an opposing second end. The work platform has a first orientation wherein the first end of the support frame is operably oriented to engage a surface, such as the ground, and the first side of the base panel provides a work platform, such as a seat or kneeler.

In a second orientation the second end of the support frame is operably oriented to engage the surface and the second side of the base panel provides a work platform, such as a seat or kneeler.

It is contemplated that the base panel may be selectively adjustable with respect to the support frame.

A first functional component is coupled to the first end of the support frame and a second functional component is coupled to the second end of said support frame. The first and second functional components may be the same or different functional components including but not limited to a rocker attachment, a wheel attachment and a stationary support attachment, for example.

### BRIEF DESCRIPTION OF THE DRAWINGS

FIG. 1 provides an embodiment of the present invention including various functional components attached thereto.

FIG. 2 provides an embodiment of the present invention in a first orientation.

FIG. 3 provides the invention shown in FIG. 2. in a second orientation.

### DESCRIPTION OF THE PRESENT INVENTION

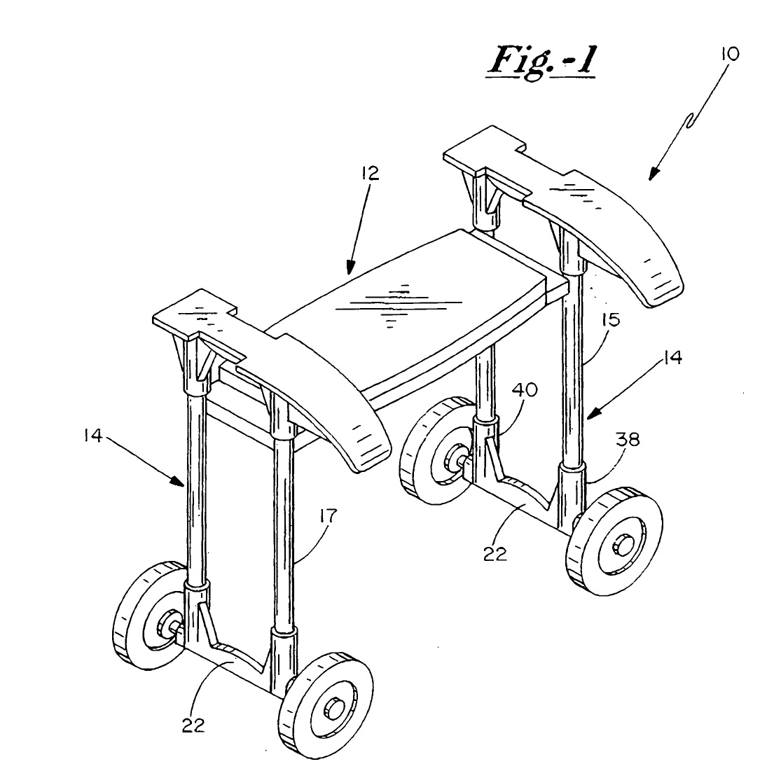

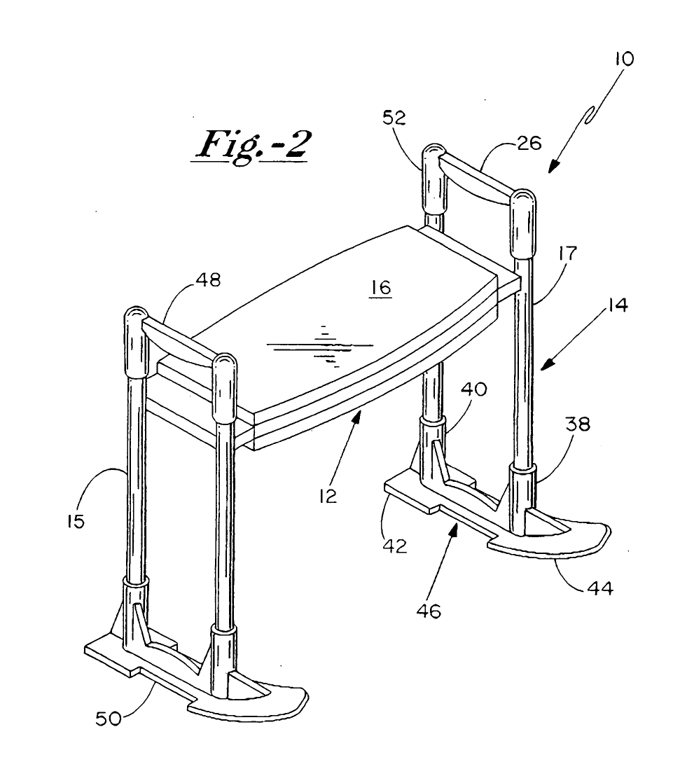

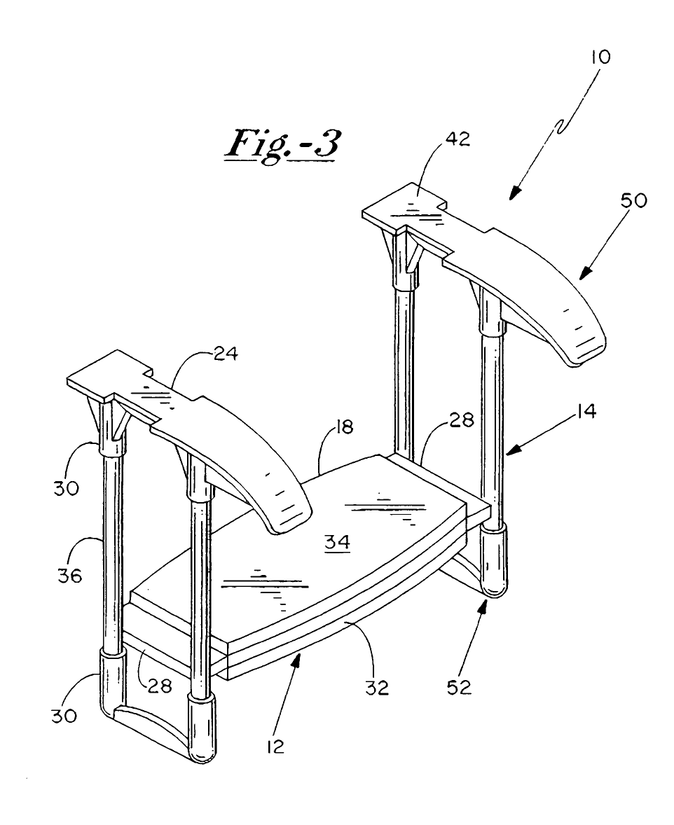

The present invention provides a multi-functional work platform 10. As shown in FIGS. 1-3 work platform 10 includes a base panel 12 that is suspended by support frame 14, and which may operate as either a seat 16 or as a kneeler 18, as shown in their respective configurations in FIGS. 2 and 3. The support frame 14 is configured to operably engage with a number of interchangeable functional components, such as wheel attachments 22, rocker attachments 24 and/or stationary attachments 26. The multi-functional work platform 10 is further configured to be operable in multiple orientations, as illustrated with reference to a first orientation in FIG. 2 and a second orientation in FIG. 3.

Support frame 14 includes first and second frame devices 15, 17 that are preferably operably coupled to opposing side sections 28 of the base panel 12. Frame devices 15, 17 preferably each include a plurality of support members 36 that each have coupling ends 30 for operably receiving various interchangeable functional components thereat. The base panel 12 includes a first side 32 and a second side 34, each side being operable as either a seat surface or kneeler surface. Such first and second sides 32, 34 may include padding material disposed thereon so as to provide added comfort to the user.

The base panel 12 may be fixedly secured at a predetermined position on the support frame 14 or, alternatively, may be selectively positionably adjustable with respect to the support frame 14. In embodiments providing for an adjustable base panel 12, a variety of conventional adjustment mechanism may be utilized. For example, engaging portions of the base panel 12 may be received within respective elongate channels (not shown) in support members 36 of the support frame 14. The base panel 12 may instead include interlocking buttons receivable in one of a plurality of locking apertures (not shown) in support members 36 of the support frame 14.

The base panel 12 therefore functions as a stationary or adjustable platform, such as a kneeler 18 or a seat platform 16 in accordance with a preference of a user, and the various embodiments of the present invention.

It is contemplated that the support frame 14 may comprise a fixed and rigid structure, or may incorporate one or more folding sections allowing the support frame 14 to be conformed to a compact configuration such as for packaging and storage. Such foldable support frame features may take on a variety of embodiments as are commonly employed in the art.

The functional components engageable with support frame 14 may include, but are not limited to, a set of wheels 22, a rocker attachment 24 and a stationary support attachment 26. Each of the functional components are configured to operably engage with respective sets of ends 30 of support members 36 in each frame device 15, 17. It is therefore contemplated that support frame 14 may include a first set of functional components at a first end and a second set of functional components at an opposing end of each frame device 15, 17. The functional components may be interchangeable, such that a first functional component is selectively attachable, removable and interchangeable with a second functional component. Alternatively, the functional components may be fixed to the support frame 14 such that a first functional component is fixedly secured at a first end of the support frame and a second functional component is fixedly secured to an opposing second end of the support frame.

FIG. 1 illustrates the functional component of a wheel attachment 22. The wheel attachment 22 is oriented to provide a travel capability in at least a first direction, with wheels 23 being mounted to either fixed or pivoting axles. Such functionality may be suitable, for example, in gardening where it is advantageous to move with respect to gardening plants without having to physically lift and/or drag the apparatus 10. Each wheel attachment 22 includes, in the present embodiment, a first and second receiving aperture 38, 40 for matingly receiving a corresponding coupling section 30 of the support frame 14 therein.

A second functional component is a rocker attachment 24. Such attachment may be used, for example to lean forward when working on a ground surface. The rocker attachment 24 includes a ground engaging surface 42 that is operationally substantially horizontal, and a rocking surface 44 defined by an upwardly curved section 46. In use, the rocking surface 44 engages the ground as the user leans forward while kneeling or sitting upon the base panel 12. As in wheel attachment 22, rocker attachment 24 preferably includes first and second receiving apertures for matingly receiving a corresponding coupling section 30 of support frame 14 therein.

A third functional component is the stationary support member 26. This member preferably provides stabilization to the base panel 12 and support frame 14, as well as a cover to respective ends of support members 36.

A user may utilize the present invention in a first orientation shown in FIG. 2 where a first end 50 engages the ground surface and a second end 52 extends upright therefrom, or a second orientation shown in FIG. 3 where the second end 52 engages the surface. Such orientation may be alternatively employed, for example, where a user wishes to change functional components from a seated function to a kneeling function. Alternatively, a user may wish to change orientation in order to engage a predetermined functional component with the ground surface, such as to change from the rocker attachment 24 to the stationary attachment 26. A user may, additionally or alternatively, change the orientation in accordance with a predetermined functional component and may adjust the height of the base panel 12 to change from a kneeler position 18 to a seat position 16 or vice-versa. Any combination of seating or kneeling may be performed with any combination of functional elements in any upright orientation, in accordance with the present invention.

What is claimed is:

1. A multi-functional work platform comprising:
a) a base panel having opposing first and second surfaces;
b) a support frame configured to operably support said base panel, said support frame having a first end and an opposing second end;
c) a first functional component coupled to said first end of said support frame; and
d) a second functional component coupled to said second end of said support frame.

4. The multi-functional work platform according to claim 1 wherein said first functional component is a wheel attachment.

5. The multi-functional work platform according to claim 1 wherein said first functional component is a rocker attachment.

6. The multi-functional work platform according to claim 1 wherein said first functional component is a stationary support attachment.

7. The multi-functional work platform according to claim 1 wherein said second functional component is a wheel attachment.

8. The multi-functional work platform according to claim 1 wherein said second functional component is a rocker attachment.

9. The multi-functional work platform according to claim 1 wherein said second functional component is a stationary support attachment.

10. A work platform comprising:
a) a first orientation wherein a first end of a support frame is operably oriented to engage a surface and a first side of a base panel provides a work platform;
b) a second orientation wherein a second end of said support frame is operably oriented to engage the surface and a second side of said base panel provides a work platform;
c) a first functional component is coupled to said first end of said support frame; and
d) a second functional component is coupled to said second end of said support frame.

11. The work platform according to claim 10 wherein said base panel functions as a kneeler in said first orientation and as a seat in said second orientation.

12. The work platform according to claim 10 wherein said base platform is selectively adjustable with respect to said support frame.

13. The work platform according to claim 10 wherein said support frame comprises a first frame device and a second frame device, each supporting an opposing side section of said base panel.

14. The work platform according to claim 13 wherein said first frame device has a rocker attachment coupled thereto and said second frame device has a rocker attachment coupled thereto.

15. The work platform according to claim 13 wherein said first frame device has a wheel attachment coupled thereto and said second frame device has a wheel attachment coupled thereto.

16. The work platform according to claim 13 wherein said first frame device has a stationary support attachment coupled thereto and said second frame device has a stationary support attachment coupled thereto.

17. The work platform according to claim 10 wherein said first functional component is selectively interchangeable with alternative functional components.

18. The work platform according to claim 17 wherein said second functional component is selectively interchangeable with alternative functional components.
